(19) United States
(12) Patent Application Publication
(10) Pub. No.: US 2015/0011230 A1
(43) Pub. Date: Jan. 8, 2015

(54) METHOD FOR COMMUNICATION BASED ON COORDINATOR IN WIRELESS COMMUNICATION SYSTEM AND APPARATUS FOR THE SAME

(71) Applicant: Electronics & Telecommunications Research Institute, Daejeon (KR)

(72) Inventors: Tae Gyun NOH, Daejeon (KR); Jae Young AHN, Daejeon (KR); Choong Il YEH, Daejeon (KR)

(73) Assignee: Electronics & Telecommunications Research Institute, Daejeon (KR)

(21) Appl. No.: 14/324,765

(22) Filed: Jul. 7, 2014

(30) Foreign Application Priority Data
Jul. 8, 2013 (KR) 10-2013-0079933
Jan. 15, 2014 (KR) 10-2014-0004865
Jul. 7, 2014 (KR) 10-2014-0084568

(51) Int. Cl. H04W 72/04

(52) U.S. Cl. CPC H04W 72/04
USPC 455/450

(57) ABSTRACT

Disclosed are a coordinator based device-to-device communication method and an apparatus for the same. The communication method may comprise transmitting a synchronization signal and system information to a plurality of terminals; configuring wireless links with the plurality of terminals based on a random access procedure; receiving a scheduling message for a D2D communication from a first terminal among the plurality of terminals; allocating, to the first terminal, a transmission resource to be used for the first terminal to transmit data based on the scheduling request message; and allocating, to a second terminal performing the D2D communication with the first terminal among the plurality of terminals, a reception resource to be used for the second terminal to receive the data transmitted from the first terminal.

### CLAIM FOR PRIORITY

This application claims priorities to Korean Patent Application No. 10-2013-0079933 filed on Jul. 8, 2013, No. 10-2014-0004865 filed on Jan. 15, 2014, and No. 10-2014-0084568 filed on Jul. 7, 2014 in the Korean Intellectual Property Office (KIPO), the entire contents of which are hereby incorporated by references.

### BACKGROUND

1. Technical Field

Example embodiments of the present invention relate to a wireless communication technology and more specifically to a device-to-device communication method based on a coordinator in a wireless communication system and an apparatus for the same.

2. Related Art

In a cellular communication environment, a general method for exchanging data between terminals is a communication method via a base station. That is, if a first terminal has data to be transmitted to a second terminal, the first terminal transmits the data to a first base station to which it belongs. Then, the first base station transmits the data received from the first terminal to a second base station to which the second terminal belongs through a core network. At last, the second base station transmits the data received from the first base station to the second terminal. Here, the first base station and the second base station may be same, or may be different.

On the other hand, a device-to-device (D2D) communication may refer to a communication method in which terminals communicate with each other without a base station. For example, when a terminal is in a radio shadow area or an adjacent base station is broken temporarily, since the terminal cannot receive a signal from the base station, the terminal may communicate with another terminal in a D2D communication manner.

Under the above-described D2D communication based wireless communication system, operation procedures for supporting a coordinator based D2D communication has not been clearly defined yet.

### SUMMARY

Accordingly, example embodiments of the present invention are provided to substantially obviate one or more problems due to limitations and disadvantages of the related art.

Example embodiments of the present invention provide a method for efficiently performing a coordinator based device-to-device communication in a wireless communication system.

Example embodiments of the present invention also provide an apparatus for efficiently performing a coordinator based device-to-device communication in a wireless communication system.

In some example embodiments, a device-to-device (D2D) communication method performed by a coordinator, the method comprises transmitting synchronization signal and system information to a plurality of terminals; configuring wireless links with the plurality of terminals based on random access procedures; receiving a scheduling request message for a D2D communication from a first terminal among the plurality of terminals; allocating, to the first terminal, a transmission resource to be used for the first terminal to transmit data based on the scheduling request message; and allocating, to a second terminal performing the D2D communication with the first terminal among the plurality of terminals, a reception resource to be used for the second terminal to receive the data.

Here, the allocating the transmission resource comprises transmitting a transmission resource allocation message including a transmission/reception identifier, information on a resource to be used for transmitting the data, and information on a cyclic shift for a demodulation reference signal (DM-RS) to the first terminal; and receiving a message including an identifier of an entity performing the D2D communication, buffer status information, and communication type information from the first terminal.

Here, in the allocating the reception resource, a reception resource allocation information including a transmission/reception identifier, information on a resource to be used for receiving the data, and information on a cyclic shift for a DM-RS is transmitted to the second terminal.

Here, the scheduling request message includes an identifier of an entity performing the D2D communication, buffer status information, and communication type information.

Here, in the allocating the transmission resource, a transmission resource allocation message including a transmission/reception identifier, information on a resource to be used for transmitting the data, and information on a cyclic shift for a DM-RS is transmitted to the first terminal.

Here, the coordinator is located within direct communication ranges of the first terminal and the second terminal.

In some example embodiments, a device-to-device (D2D) communication method performed by a coordinator, the method comprises transmitting synchronization signal and system information to a first terminal; configuring a wireless link with the first terminal based on a random access procedure; transmitting, to the first terminal, a resource allocation message for allocating a resource to be used for the first terminal to receive data; and transmitting the data to the first terminal through the resource.

Here, the resource allocation message includes a transmission/reception identifier, information on a resource to be used for transmitting the data, and information on a cyclic shift for a demodulation reference signal (DM-RS).

Here, the resource allocation message further includes an identifier of an entity performing the D2D communication, buffer status information, and communication type information.

Here, the coordinator is a terminal located within a direct communication range of the first terminal.

In some example embodiments, a device-to-device (D2D) communication method performed by a first terminal, the method comprises establishing a synchronization with a coordinator based on a synchronization signal received from the coordinator; receiving system information from the coordinator; configuring a wireless link with the coordinator based on a random access procedure; transmitting a scheduling request message for a D2D communication to the coordinator; receiving, from the coordinator, a resource allocation message including information on a resource to be used for transmitting data; and transmitting the data to the coordinator through the resource.

Here, the receiving the resource allocation message comprises receiving a resource allocation message including a transmission/reception identifier, information on the resource to be used for transmitting the data, and information on a cyclic shift for a demodulation reference signal (DM-RS) from the coordinator; and transmitting a message including an identifier of an entity performing the D2D communication, buffer status information, and communication type information to the coordinator.

Here, the scheduling request message includes an identifier of an entity performing the D2D communication, buffer status information, and communication type information.

Here, in the receiving the resource allocation message, resource allocation information including the transmission/reception identifier, the information on the resource to be used for transmitting the data, and the information on the cyclic shift for the DM-RS is received from the coordinator.

Here, the coordinator is a terminal located within a direct communication range of the first terminal.

According to the present invention, a coordinator based D2D communication may be performed efficiently in a wireless communication system.

### BRIEF DESCRIPTION OF DRAWINGS

Example embodiments of the present invention will become more apparent by describing in detail example embodiments of the present invention with reference to the accompanying drawings, in which:

FIG. 1 is a block diagram illustrating an example embodiment of a station performing methods according to the present invention;

FIG. 2 is a conceptual diagram illustrating a communication environment in which a base station does not exist;

FIG. 3 is a flow chart illustrating a D2D communication method based on a coordinator according to an example embodiment of the present invention;

FIG. 4 is a flow chart illustrating a D2D communication method performed by a coordinator according to an example embodiment of the present invention;

FIG. 5 is a flow chart illustrating a D2D communication method performed by a terminal according to an example embodiment of the present invention; and

FIG. 6 is a flow chart illustrating a D2D communication method based on a coordinator according to other example embodiment of the present invention.

### DESCRIPTION OF EXAMPLE EMBODIMENTS

Example embodiments of the present invention are disclosed herein. However, specific structural and functional details disclosed herein are merely representative for purposes of describing example embodiments of the present invention, however, example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In the entire specification, a network may include a wireless internet such a wireless fidelity (WIFI), a portable internet such as a wireless broadband internet (WiBro) or a world interoperability for microwave access (WiMax), a 2G mobile communication network such as a global system for mobile communication (GSM) or a code division multiple access (CDMA), a 3G mobile communication network such as a wideband code division multiple access (WCDMA) or CDMA2000, a 3.5G mobile communication network such as a high speed downlink packet access (HSDPA) or a high speed uplink packet access (HSUPA), a 4G mobile communication network such as a long term evolution (LTE) or a LTE-Advanced, and a 5G mobile communication network.

Also, in the entire specification, the ‘terminal may’ refer to user equipment (UE), a mobile station (MS), a user terminal (UT), a wireless terminal, an access terminal (AT), a terminal, a subscriber unit, a subscriber station (SS), a wireless device, a wireless communication device, a wireless transmission/reception unit (WTRU), a mobile node, a mobile, or other terms.

Various embodiments of the terminal may include a cellular phone, a smart phone having a wireless communication function, a personal digital assistant (PDA) having a wireless communication function, a wireless modem, a portable computer having a wireless communication function, a photographing device such as a digital camera having a wireless communication function, a gaming device having a wireless communication function, music storage and reproduction appliances having a wireless communication function, Internet appliances enabling wireless Internet connection and browsing, and a portable unit or terminals with integrated combinations of such functions, but are not limited thereto.

Also, the term “base station” used in this specification means a fixed point that communicates with terminals, and may be referred to as another word, such as Node-B, eNode-B, a base transceiver system (BTS), an access point, etc. Also, the term “base station” means a controlling apparatus which controls at least one cell. In a real wireless communication system, a base station may be connected to and controls a plurality of cells physically, in this case, the base station may be regarded to comprise a plurality of logical base stations. That is, parameters configured to each cell are assigned by the corresponding base station.

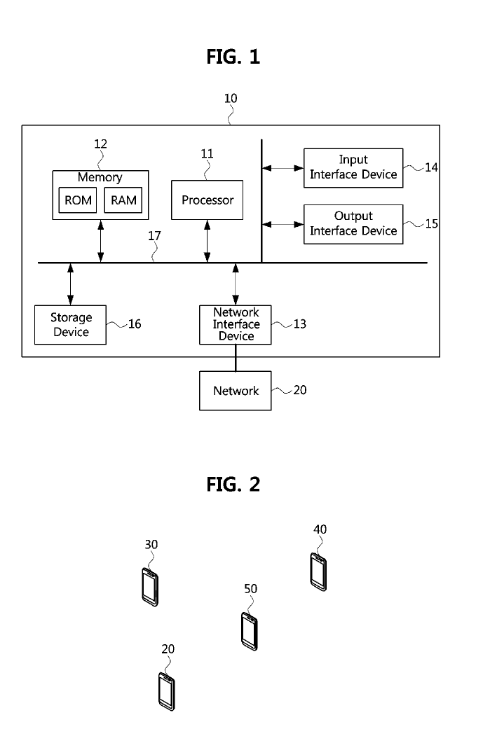

FIG. 1 is a block diagram illustrating an example embodiment of a station performing methods according to the present invention.

Referring to FIG. 1, a station 10 may comprise at least one processor 11, a memory 12, and a network interface device 13 performing communications with a network 20. In addition, the station 10 may further comprise an input interface device 14, an output interface device 15, and a storage device 16, etc. Each components constituting the station 10 may be connected through a bus 17, and communicate with each other.

The processor 11 may execute program codes stored in the memory 12 and/or the storage device 16. The processor 11 may be a central processing unit (CPU), a graphics processing unit (GPU), or a dedicated processor on which the methods according to the present invention are performed. The memory 12 and the storage device 16 may be configured with at least one volatile memory device and/or at least one non-volatile memory device. For example, the memory 12 may be configured with a read-only memory (ROM) and/or a random access memory (RAM).

FIG. 2 is a conceptual diagram illustrating a communication environment in which a base station does not exist.

Referring to FIG. 2, terminals 20, 30, 40, and 50 cannot receive signals from a base station when they are located in a radio shadow area or the base station is broken temporarily. In this case, the terminals may perform device-to-device (D2D) communications with each other. When the D2D communications are performed, one of the terminals 20, 30, 40, and 50 may become a coordinator. For example, a fourth terminal 50 among the terminals may operate as a coordinator.

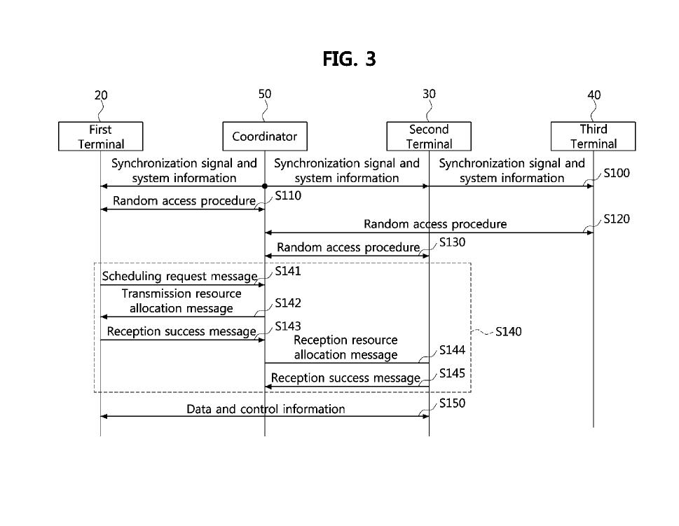

FIG. 3 is a flow chart illustrating a D2D communication method based on a coordinator according to an example embodiment of the present invention.

Referring to FIG. 3, a plurality of terminal 20, 30, 40, and 50 may mean entities illustrated in FIG. 2. The terminals 20, 30, 40, and 50 may perform D2D communications with each other. The fourth terminal 50 among the terminals may operate as a coordinator. A first terminal 20, a second terminal 30, and a third terminal 40 may be located within a communication range of the coordinator 50. Meanwhile, the coordinator 50 may also be a base station.

The coordinator 50 may transmit a synchronization signal and system information (S100). At this time, the coordinator 50 may transmit the synchronization signal and the system information in a broadcast manner. For example, the synchronization signal may include a primary synchronization signal (PSS) and a secondary synchronization signal (SSS). Each of the terminals 20, 30, and 40 may establish synchronization with the coordinator by using the synchronization signal received from the coordinator 50.

Meanwhile, the system information may include a master information block (MIB), a system information block (SIB), etc. For example, each of the terminals 20, 30, and 40 may obtain the MIB through a physical broadcast channel (PBCH) and the SIB through a physical downlink shared channel (PDSCH).

Each of the terminals 20, 30, and 40 may configure a wireless link with the coordinator 50 based on random access procedures (S110, S120, and S130). In FIG. 3, as an example, a random access procedure between the first terminal 20 and the coordinator 50 is performed, and then a random access procedure between the third terminal 40 and the coordinator 50 is performed. At last, a random access procedure between the second terminal 30 and the coordinator 50 is performed. However, an operation order of the random access procedures is not restricted to the above example.

Here, the above random access procedures may be performed based on a manner specified in the 3GPP Long-Term Evolution (LTE) standard. For example, each of the terminals 20, 30, and 40 may transmit a random access preamble message for uplink synchronization to the coordinator 50, and receive a random access response message including timing advance information in response to the random access preamble message from the coordinator 50. Then, each of the terminals 20, 30, and 40 may transmit a message including its terminal identifier, etc. to the coordinator 50. In response to the message, the coordinator 50 may transmit a message including its terminal identifier, a group identifier, etc. to each of the terminals 20, 30, and 40. Here, the terminal identifier may be configured differently for each terminal The coordinator 50 may assign the same group identifier to a plurality of terminals, or a plurality of group identifiers to a single terminal. Also, the coordinator 50 may manage the plurality of group identifiers.

Then, a scheduling procedure between the first terminal 20, the second terminal 30, and the coordinator 50 may be performed (S140). A resource to be used for the D2D communications between the first terminal 20 and the second terminal 30 may be allocated using one of or both the following two manners.

### A First Resource Allocation Manner

The first terminal 20 may transmit a scheduling request message for the D2D communications to the coordinator 50 (S141). When the coordinator 50 receives the scheduling request message, it may generate a transmission resource allocation message including a transmission/reception identifier, information on a resource to be used for the D2D communications (that is, a resource used for transmitting a message to the second terminal 30), information on a cyclic shift for a demodulation reference signal (DM-RS), etc., and transmit the generated transmission resource allocation message to the first terminal 20 (S142). Here, the transmission/reception identifier means an identifier indicating whether the message is for allocating resources for transmission or for allocating resources for reception. The transmission resource allocation message may further include at least one of a terminal identifier of the first terminal 20 and a group identifier corresponding to the first terminal 20. The first terminal 20 may receive the transmission resource allocation message by descrambling the transmission resource allocation message based on its terminal identifier and group identifier obtained through the random access procedure.

When the first terminal 20 receives the transmission resource allocation message successfully, it may transmit a message including communication type information, an identifier of a counterpart entity (that is, the second terminal 30) of the D2D communications, buffer status information, etc. to the coordinator 50 (S143). Here, the first terminal 20 may notify that the transmission resource allocation message is received successfully to the coordinator 50 by transmitting the message.

The communication type may be one of a unicast type communication, a broadcast type communication, and a multicast type communication. The identifier of the counterpart entity may be a terminal identifier or a group identifier of the counterpart entity. The buffer status information may include information about amount of data to be transmitted by the first terminal 20. Here, the communication type information, the identifier of the counterpart entity, the buffer status information, etc. may be transmitted to the coordinator 50 as included in at least one medium access control (MAC) control element.

Also, the coordinator 50 may generate a reception resource allocation message including a transmission/reception identifier, information on a resource to be used for the D2D communications (that is, a resource used for receiving a message from the first terminal 20), information on a cyclic shift for a DM-RS, etc., and transmit the generated reception resource allocation message to the second terminal 30 (S144). The reception resource allocation message may further include at least one of a terminal identifier of the second terminal 30 and a group identifier corresponding to the second terminal 30. The second terminal 30 may receive the reception resource allocation message by descrambling the reception resource allocation message based on its terminal identifier and group identifier obtained through the random access procedure. When the reception resource allocation message is received successfully, the second terminal 30 may transmit a reception success message in response to the reception resource allocation message to the coordinator 50 (S145).

### A Second Resource Allocation Manner

The first terminal 20 may transmit a scheduling request message for the D2D communications to the coordinator 50 (S141). The scheduling request message may include communication type information, an identifier of a counterpart entity (that is, the second terminal 30) of the D2D communications, buffer status information, etc. Here, the communication type may be one of a unicast type communication, a broadcast type communication, and a multicast type communication. The identifier of the counterpart entity may be a terminal identifier or a group identifier of the counterpart entity. The buffer status information may include information about amount of data to be transmitted by the first terminal 20.

When the coordinator 50 receives the scheduling request message, it may generate a transmission resource allocation message including a transmission/reception identifier, information on a resource to be used for the D2D communications (that is, a resource used for transmitting a message to the second terminal 30), information on a cyclic shift for a demodulation reference signal (DM-RS), etc., and transmit the generated transmission resource allocation message to the first terminal 20 (S142). The transmission resource allocation message may further include at least one of a terminal identifier of the first terminal 20 and a group identifier corresponding to the first terminal 20. The first terminal 20 may receive the transmission resource allocation message by descrambling the transmission resource allocation message based on its terminal identifier and group identifier obtained through the random access procedure. The first terminal 20 may transmit a reception success message to the coordinator 50 when receiving the transmission resource allocation message successfully (S143).

The coordinator 50 may generate a reception resource allocation message including a transmission/reception identifier, information on a resource to be used for the D2D communications (that is, a resource used for receiving a message from the first terminal 20), information on a cyclic shift for a demodulation reference signal (DM-RS), etc., and transmit the generated reception resource allocation message to the second terminal 30 (S144). The reception resource allocation message may further include at least one of a terminal identifier of the second terminal 30 and a group identifier corresponding to the second terminal 30. The second terminal 30 may receive the reception resource allocation message by descrambling the reception resource allocation message based on its terminal identifier and group identifier obtained through the random access procedure. When the reception resource allocation message is received successfully, the second terminal 30 may transmit a reception success message in response to the reception resource allocation message to the coordinator 50 (S145).

After the completion of the scheduling procedure, the first terminal 20 may transmit data and control information to the second terminal 30 through the resource allocated by the coordinator 50 (S150).

Here, the control information may include hybrid automatic retransmit request (HARQ) information, modulation and coding scheme (MCS) information, power control information, etc. The first terminal 20 may scramble the data based on its terminal identifier (or, its group identifier) or a terminal identifier (or, a group identifier) of the second terminal 30. Also, the first terminal 20 may scramble the data based on the identifier included in the transmission resource allocation information or the identifier included in the reception resource allocation information.

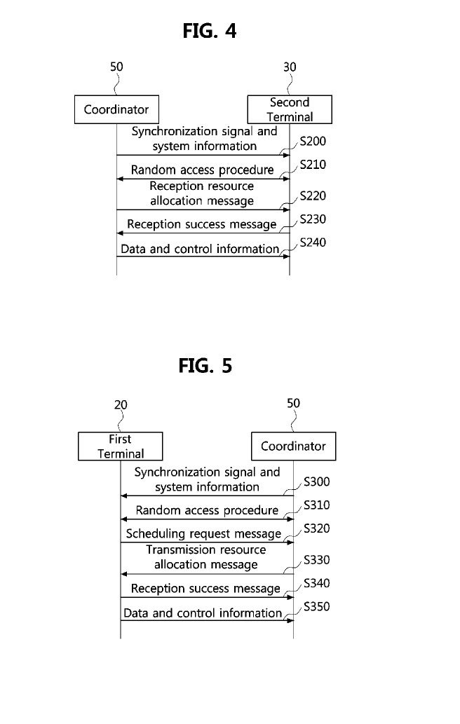

FIG. 4 is a flow chart illustrating a D2D communication method performed by a coordinator according to an example embodiment of the present invention.

Referring to FIG. 4, a plurality of terminals 30 and 50 may mean entities illustrated in FIG. 2. The terminals 30 and 50 may perform D2D communications with each other. The fourth terminal 50 among the terminals may operate as a coordinator. The second terminal 30 may be located within a communication range of the coordinator 50. Meanwhile, the coordinator 50 may also be a base station.

The coordinator 50 may transmit a synchronization signal and system information (S200). Here, a detail operation of the step 200 may be identical to the step S100 explained referring to FIG. 3 The second terminal 30 may configure a wireless link with the coordinator 50 based on a random access procedure (S210). Here, a detail operation of the step S210 may be identical to the step S130 explained referring to FIG. 3.

The coordinator 50 may generate a reception resource allocation message including a transmission/reception identifier, information on a resource to be used for the D2D communications (that is, a resource used for receiving a message from the coordinator 50), information on a cyclic shift for a demodulation reference signal (DM-RS), etc., and transmit the generated reception resource allocation message to the second terminal 30 (S220). Also, the reception resource allocation message may further include at least one of communication type information, an identifier of an entity performing the D2D communications (that is, an identifier of the second terminal 30), buffer status information, etc. The communication type may be one of a unicast type communication, a broadcast type communication, and a multicast type communication. The identifier of the entity performing the D2D communications may be a terminal identifier or a group identifier of the entity. The buffer status information may include information about amount of data to be transmitted by the coordinator 50.

The second terminal 30 may receive the reception resource allocation message by descrambling the reception resource allocation message based on its terminal identifier and group identifier obtained through the random access procedure. When the reception resource allocation message is received successfully, the second terminal 30 may transmit a reception success message in response to the reception resource allocation message to the coordinator 50 (S230).

The coordinator 50 may transmit data and control information to the second terminal 30 through the allocated resource (S240). Here, the control information may include hybrid automatic retransmit request (HARQ) information, modulation and coding scheme (MCS) information, power control information, etc. The coordinator 50 may scramble the data based on its terminal identifier (or, its group identifier) or a terminal identifier (or, a group identifier) of the second terminal 30. Also, the coordinator 50 may scramble the data based on the identifier included in the reception resource allocation information.

FIG. 5 is a flow chart illustrating a D2D communication method performed by a terminal according to an example embodiment of the present invention.

Referring to FIG. 5, a plurality of terminals 20 and 50 may mean entities illustrated in FIG. 2. The terminals 20 and 50 may perform D2D communications with each other. The fourth terminal 40 among the terminals may operate as a coordinator. The first terminal 20 may be located within a communication range of the coordinator 50. Meanwhile, the coordinator 50 may also be a base station.

The coordinator 50 may transmit a synchronization signal and system information (S300). Here, a detail operation of the step 300 may be identical to the step S100 explained referring to FIG. 3 The first terminal 20 may configure a wireless link with the coordinator 50 based on a random access procedure (S310). Here, a detail operation of the step S310 may be identical to the step S110 explained referring to FIG. 3.

Then, a scheduling procedure between the first terminal 20 and the coordinator 50 may be performed. A resource to be used for D2D communications between the first terminal 20 and the coordinator 50 may be allocated using one of or both the following two manners.

### A First Resource Allocation Manner

The first terminal 20 may transmit a scheduling request message for the D2D communications to the coordinator 50 (S320). When the coordinator 50 receives the scheduling request message, it may generate a transmission resource allocation message including a transmission/reception identifier, information on a resource to be used for the D2D communications, information on a cyclic shift for a DM-RS, etc., and transmit the generated transmission resource allocation message to the first terminal 20 (S330). Here, a detail operation of the step S330 may be identical to the step S142 of the ‘first resource allocation manner’ explained referring to FIG. 3.

When the transmission resource allocation message is received successfully, the first terminal 20 may transmit a message including communication type information, an identifier of an entity performing the D2D communications (that is, an identifier of the coordinator 50), buffer status information, etc. to the coordinator 50 (S340). Here, a detail operation of the step S340 may be identical to the step S143 of the ‘first resource allocation manner’ explained referring to FIG. 3.

### A Second Resource Allocation Manner

The first terminal 20 may transmit a scheduling request message including communication type information, an identifier of an entity performing the D2D communications (that is, an identifier of the coordinator 50), buffer status information, etc. to the coordinator 50 (S320). Here, a detail operation of the step S320 may be identical to the step S141 of the ‘second resource allocation manner’ explained referring to FIG. 3.

When the coordinator 50 receives the scheduling request message, it may generate a transmission resource allocation message including a transmission/reception identifier, information on a resource to be used for the D2D communications, information on a cyclic shift for a DM-RS, etc., and transmit the generated transmission resource allocation message to the first terminal 20 (S330). Here, a detail operation of the step S330 may be identical to the step S142 of the second resource allocation manner explained referring to FIG. 3.

The first terminal 20 may transmit a reception success message to the coordinator 50 when it receives the transmission resource allocation message successfully (S340). Here, a detail operation of the step S340 may be identical to the step S143 of the second resource allocation manner explained referring to FIG. 3.

After the scheduling procedure, the first terminal 20 may transmit data and control information to the coordinator 50 through the allocated resource (S350). Here, the control information may include hybrid automatic retransmit request (HARQ) information, modulation and coding scheme (MCS) information, power control information, etc. The first terminal 20 may scramble the data based on its terminal identifier (or, its group identifier) or a terminal identifier (or, a group identifier) of the coordinator 50. Also, the first terminal 20 may scramble the data based on the identifier included in the transmission resource allocation information.

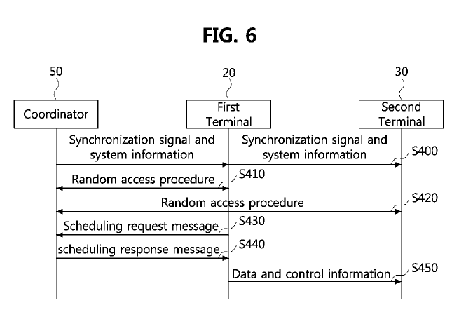

FIG. 6 is a flow chart illustrating a D2D communication method based on a coordinator according to other example embodiment of the present invention.

Referring to FIG. 6, a plurality of terminal 20, 30, and 50 may mean entities illustrated in FIG. 2. The terminals 20, 30, and 50 may perform D2D communications with each other. The fourth terminal 50 among the terminals may operate as a coordinator. The first terminal 20 and the second terminal 30 may be located within a communication range of the coordinator 50. Meanwhile, the coordinator 50 may also be a base station. The coordinator 50 may allocate a resource in at least one resource region to a terminal Here, the resource region may be configured with at least one subframe and at least one physical resource block (PRB). The resource region may be configured by the coordinator 50 or configured in advance.

The resource may be configured with at least one PRB, and an index of the resource may be defined within a resource region. When the coordinator 50 is a base station, the coordinator may be assumed to know terminal identifiers of all terminals. When the coordinator 50 is a terminal, the coordinator may be assumed to know at least terminal identifiers of terminals belonging to the same group. The terminal identifier may be configured with a group identifier and a member identifier, and the member identifier can be defined within a group.

The coordinator 50 may transmit a synchronization signal and system information (S400). Here, a detail operation of the step 400 may be identical to the step S100 explained referring to FIG. 3 The first terminal 20 may configure a wireless link with the coordinator 50 based on a random access procedure (S410). Here, a detail operation of the step S410 may be identical to the step S110 explained referring to FIG. 3. The second terminal 30 may configure a wireless link with the coordinator 50 based on a random access procedure (S420). Here, a detail operation of the step S420 may be identical to the step S130 explained referring to FIG. 3.

The first terminal 20 may transmit a scheduling request message for the D2D communications to the coordinator 50 (S430). In this case, the first terminal 20 may transmit the scheduling request message to the coordinator 50 by using at least one of a physical uplink control channel (PUCCH), a physical random access channel (PRACH), a physical uplink shared channel (PUSCH), and a D2D discovery channel which are defined in the 3GPP standard.

The scheduling request message may include at least one of a terminal identifier, indexes and number of resource regions having received signal strength not less than a preconfigured threshold, information on a cyclic shift for each of the resource regions, buffer status information, and communication type information. Here, the communication type may be one of a unicast type communication, a broadcast type communication, and a multicast type communication.

Specifically, the first terminal 20 may generate information included in the scheduling request message in the following manner. The first terminal 20 may measure received signal strengths of resource regions, and obtain the indexes and number of resource regions having received signal strength not less than the preconfigured threshold. Here, the first terminal 20 may determine that signal is transmitted through each resource region (that is, a busy state) when a received signal strength of each resource region is not less than the preconfigured threshold. On the contrary, the first terminal 20 may determine that signal is not transmitted through each resource region (that is, an idle state) when a received signal strength of each resource region is below the preconfigured threshold. Also, the first terminal 20 may obtain the information about cyclic shifts for DM-RS used in each of the resource regions.

The coordinator 50 may generate a scheduling response message based on the information included in the scheduling request message, and transmit the generated scheduling response message to the first terminal 20 (S440). In this case, the coordinator 50 may transmit the scheduling response message to the first terminal 20 in a downlink control information (DCI) format through PDSCH, PUSCH, and D2D discovery channel which are defined in the 3GPP standard. Here, the DCI format may be scrambled using a cell-radio network temporary identifier (C-RNTI) of the first terminal 20 for Cyclic Redundancy Check (CRC). Also, DCI format 1A or 1C may be scrambled by using a random access-RNTI (RA-RNTI) of the first terminal 20 for CRC, and the scrambled DCI format 1A or 1C may be transmitted through PDSCH. Also, scrambling sequences for PUSCH and D2D discovery channel may be initialized using the terminal identifier.

The scheduling response message may include at least one of information on allocation of resources to be used for the D2D communications, an identifier of HARQ process, information on cyclic shift of DM-RS, and MCS information. Here, the information on the allocation of resource may include an index of resource region and an index of resource.

Specifically, the coordinator 50 may generate information included in the scheduling response message in the following manner. The coordinator 50 may configure resources to be used for the D2D communication considering the indexes and number of resource regions included in the scheduling request message so that as many resource regions having a received signal strength not less than the preconfigured threshold as possible are precluded. Alternatively, the coordinator 50 may determine resource regions having a received signal strength not less than the preconfigured threshold by directly measuring received signal strengths of resource regions without considering the information included in the scheduling request message, and configure resources to be used for the D2D communication so that resource regions having a received signal strength not less than the preconfigured threshold are precluded. The coordinator 50 may allocate a different HARQ process identifier for each of terminals belonging to the same group. The coordinator 50 may configure a cyclic shift of DM-RS for the D2D communications so that as many cyclic shifts included in the scheduling request message as possible are precluded. The coordinator 50 may select a MCS based on the buffer status information included in the scheduling request message.

The first terminal 20 may transmit data and control information to the second terminal 30 based on the information included in the scheduling response message (S450). For example, the first terminal 20 may transmit a message including the data and the control information to the second terminal 30 through PUSCH, D2D discovery channel, etc. which are defined in the 3GPP standard.

The control information may include a HARQ process identifier and at least one of MCS information and a new data indicator (NDI). Here, the HARQ process identifier may be identical to the HARQ process identifier included in the scheduling response message. The MCS may be identical to the MCS included in the scheduling response message, or be determined by the first terminal 20. The sequence of DM-RS may be determined according to the group identifier. The cyclic shift for the DM-RS may be identical to the one included in the scheduling response message, or be determined by the first terminal 20. The scrambling sequence for the data may be initialized by the group identifier or the HARQ process identifier, or be initialized by a combination of the group identifier and the HARQ process identifier.

The second terminal 30 may identify a resource region which it belongs to by demodulating the DM-RS sequence of the data based on its group identifier. The second terminal 30 may identify a resource region through which the data is transmitted by blind-decoding the control information in the resource region which it belongs to. The second terminal 30 may demodulate the data based on the control information.

The example embodiments of the present invention can be implemented in the form of a program command that can be executed through a variety of computer means and recorded in a computer-readable medium. The computer-readable medium may include to program commands, data files, data structures, etc. in a single or combined form. The program commands recorded in the computer-readable medium may be program commands that are specially designed and configured for the example embodiments of the present invention, or program commands that are publicized and available for those of ordinary skill in the art of computer software.

Examples of the computer-readable medium include hardware devices, such as a read-only memory (ROM), a random access memory (RAM), and a flash memory, specially configured to store and execute program commands. Examples of the program commands include advanced language codes that can be executed by a computer using an interpreter, etc., as well as machine language codes, such as those generated by a compiler. The hardware devices may be configured to operate as at least one software module so as to perform operations of the example embodiments of the present invention, and vice versa.

While the example embodiments of the present invention and their advantages have been described in detail, it should be understood that various changes, substitutions and alterations may be made herein without departing from the scope of the invention.

What is claimed is:

1. A device-to-device (D2D) communication method performed by a coordinator, the method comprising:
transmitting synchronization signal and system information to a plurality of terminals;
configuring wireless links with the plurality of terminals based on random access procedures;
receiving a scheduling request message for a D2D communication from a first terminal among the plurality of terminals;
allocating, to the first terminal, a transmission resource to be used for the first terminal to transmit data based on the scheduling request message; and
allocating, to a second terminal performing the D2D communication with the first terminal among the plurality of terminals, a reception resource to be used for the second terminal to receive the data.

2. The method of claim 1, wherein the allocating the transmission resource comprises:
transmitting a transmission resource allocation message including a transmission/reception identifier, information on a resource to be used for transmitting the data, and information on a cyclic shift for a demodulation reference signal (DM-RS) to the first terminal; and
receiving a message including an identifier of an entity performing the D2D communication, buffer status information, and communication type information from the first terminal.

3. The method of claim 1, wherein, in the allocating the reception resource, a reception resource allocation information including a transmission/reception identifier, information on a resource to be used for receiving the data, and information on a cyclic shift for a DM-RS is transmitted to the second terminal.

4. The method of claim 1, wherein the scheduling request message includes an identifier of an entity performing the D2D communication, buffer status information, and communication type information.

5. The method of claim 4, wherein, in the allocating the transmission resource, a transmission resource allocation message including a transmission/reception identifier, information on a resource to be used for transmitting the data, and information on a cyclic shift for a DM-RS is transmitted to the first terminal.

6. The method of claim 1, wherein the coordinator is located within direct communication ranges of the first terminal and the second terminal.

7. A device-to-device (D2D) communication method performed by a coordinator, the method comprising:
transmitting synchronization signal and system information to a first terminal;
configuring a wireless link with the first terminal based on a random access procedure;
transmitting, to the first terminal, a resource allocation message for allocating a resource to be used for the first terminal to receive data; and
transmitting the data to the first terminal through the resource.

8. The method of claim 7, wherein the resource allocation message includes a transmission/reception identifier, information on a resource to be used for transmitting the data, and information on a cyclic shift for a demodulation reference signal (DM-RS).

9. The method of claim 8, wherein the resource allocation message further includes an identifier of an entity performing the D2D communication, buffer status information, and communication type information.

10. The method of claim 7, wherein the coordinator is a terminal located within a direct communication range of the first terminal

11. A device-to-device (D2D) communication method performed by a first terminal, the method comprising:
establishing a synchronization with a coordinator based on a synchronization signal received from the coordinator;
receiving system information from the coordinator;
configuring a wireless link with the coordinator based on a random access procedure;
transmitting a scheduling request message for a D2D communication to the coordinator;
receiving, from the coordinator, a resource allocation message including information on a resource to be used for transmitting data; and
transmitting the data to the coordinator through the resource.

12. The method of claim 11, wherein the receiving the resource allocation message comprises:
receiving a resource allocation message including a transmission/reception identifier, information on the resource to be used for transmitting the data, and information on a cyclic shift for a demodulation reference signal (DM-RS) from the coordinator; and
transmitting a message including an identifier of an entity performing the D2D communication, buffer status information, and communication type information to the coordinator.

13. The method of claim 11, wherein the scheduling request message includes an identifier of an entity performing the D2D communication, buffer status information, and communication type information.

14. The method of claim 13, wherein, in the receiving the resource allocation message, resource allocation information including the transmission/reception identifier, the information on the resource to be used for transmitting the data, and the information on the cyclic shift for the DM-RS is received from the coordinator.

15. The method of claim 11, wherein the coordinator is a terminal located within a direct communication range of the first terminal.
